(19) United States
(12) Patent Application Publication
(10) Pub. No.: US 2025/0183485 A1
(43) Pub. Date: Jun. 5, 2025

(54) BATTERY

(71) Applicant: TOYOTA JIDOSHA KABUSHIKI KAISHA, Toyota-shi (JP)

(72) Inventor: Naotaka Tanimoto, Nisshin-shi (JP)

(73) Assignee: TOYOTA JIDOSHA KABUSHIKI KAISHA, Toyota-shi (JP)

(21) Appl. No.: 18/799,256

(22) Filed: Aug. 9, 2024

(30) Foreign Application Priority Data
Dec. 4, 2023 (JP) 2023-204826

(51) Int. Cl. H01M 50/474; H01M 4/02; H01M 50/46; H01M 50/486

(52) U.S. Cl. CPC H01M 50/474; H01M 50/46; H01M 50/486; H01M 2004/029

(57) ABSTRACT

A laminate configured by laminating a plurality of bipolar electrodes and a plurality of separators in a lamination direction is included, and a frame body that is made of resin and is provided at an outer peripheral portion of the laminate such that the frame body is connected to current collector foils that are parts of current collectors of the bipolar electrodes where positive electrode active material layers and negative electrode active material layers are not formed and spacers that are made of an insulating material and are located between the current collector foils and the separators such that the distance in a perpendicular direction that is a direction perpendicular to the lamination direction up to the positive electrode active material layers and the negative electrode active material layers is longer than the distance in the perpendicular direction up to the frame body are included.

### CROSS-REFERENCE TO RELATED APPLICATION

This application claims priority to Japanese Patent Application No. 2023-204826 filed on Dec. 4, 2023, incorporated herein by reference in its entirety.

### BACKGROUND

### 1. Technical Field

The present disclosure relates to a battery.

### 2. Description of Related Art

Japanese Unexamined Patent Application Publication No. 2018-049794 (JP 2018-049794 A) below discloses a battery in which a plurality of electrodes including bipolar electrodes and a plurality of separators located between adjacent electrodes are laminated in a predetermined lamination direction. The bipolar electrodes include current collectors, positive electrode active material layers that are formed on surfaces of the current collectors on one side and have outer peripheral side end portions located on a side closer to an inner periphery than outer peripheral side end portions of the current collectors, and negative electrode active material layers that are formed on the other surfaces of the current collectors and have outer peripheral side end portions located on the side closer to the inner periphery than the outer peripheral side end portions of the current collectors. The battery further includes a frame body that is made of resin and is provided at an outer peripheral portion of the laminate such that the frame body is connected to current collector foils which are parts of the current collectors where the positive electrode active material layers and the negative electrode active material layers are not formed. The battery further includes spacers that are located between the adjacent current collector foils and are connected to an inner peripheral surface of the frame body.

### SUMMARY

The spacers of the battery of JP 2018-049794 A described above are connected to the inner peripheral surface of the frame body. In other words, the distance from the positive electrode active material layers and the negative electrode active material layers to the spacers is long. Therefore, there is a concern that when an external force is imparted on the battery, the part of the current collector foil of at least one current collector with a short distance to the positive electrode active material layers and the negative electrode active material layers may be deformed and may be brought into contact with a current collector foil of another current collector while penetrating through a separator. When the two current collector foils are short-circuited in this manner, the temperature of the positive electrode active material layers and the negative electrode active material layers tends to increase due to heat generated through the short-circuiting.

In view of the above, it is an object of the present disclosure to provide a battery in which short-circuiting that tends to raise the temperature of the positive electrode active material layers and the negative electrode active material layers is unlikely to occur between two current collector foils when an external force is imparted.

A battery according to a first aspect includes: a laminate configured by laminating a plurality of bipolar electrodes and a plurality of separators in a predetermined lamination direction, the bipolar electrodes each including a current collector, a positive electrode active material layer provided on one surface of the current collector and including an outer peripheral side end portion located on a side closer to an inner periphery than an outer peripheral side end portion of the current collector, and a negative electrode active material layer provided on another surface of the current collectors and including an outer peripheral side end portion located on the side closer to the inner periphery than the outer peripheral side end portion of the current collector, the separators being each located between the positive electrode active material layer and the negative electrode active material layer;
a frame body that is made of resin and is provided at an outer peripheral portion of the laminate such that the frame body is connected to current collector foils that are parts of the current collectors where the positive electrode active material layers and the negative electrode active material layers are not provided; and
a spacer that is made of an insulating material and is located between the current collector foil and the separator such that a distance in a perpendicular direction up to the positive electrode active material layer and the negative electrode active material layer is longer than a distance in the perpendicular direction up to the frame body, the perpendicular direction being a direction perpendicularly intersecting the lamination direction.

When an external force is imparted on the battery according to the first aspect, a current collector foil of at least one current collector may be deformed and may be brought into contact with another current collector foil while penetrating through a separator. At this time, the spacer made of the insulating material and located between the current collector foil and the separator reduces contact of the portion of the collector foil with a short distance in the perpendicular direction up to the positive electrode active material layer and the negative electrode active material layer with another current collector foil. Therefore, short-circuiting that tends to raise the temperature of the positive electrode active material layer and the negative electrode active material layer is unlikely to occur between the two current collector foils when an external force is imparted on the battery according to the first aspect.

In the battery according to a second aspect,
in the first aspect,
the outer peripheral side end portion of the negative electrode active material layer is located on a side closer to an outer periphery than the outer peripheral side end portion of the positive electrode active material layer,
the spacer is provided on the current collector such that the spacer faces the positive electrode active material layer in the perpendicular direction from an outer peripheral side, and
at least some of the spacer overlaps the outer peripheral side end portion of the negative electrode active material layer as viewed in the lamination direction.

In the battery of the second aspect, the distance between the spacer and the positive electrode active material layer in the perpendicular direction is short. Therefore, short-circuiting that tends to raise the temperature of the positive electrode active material layers is unlikely to occur between the two current collector foils when an external force is imparted on the battery of the second embodiment.

In the battery according to a third aspect,
in the first aspect or the second aspect,
a dimension of the spacer and a dimension of the positive electrode active material layer in the lamination direction are the same.

According to the third aspect, short-circuiting that tends to raise the temperature of the positive electrode active material layer and the negative electrode active material layer is unlikely to occur between the two current collector foils when an external force is imparted on the battery as compared with a case where the dimension of the spacer in the lamination direction is smaller than the dimension of the positive electrode active material layer in the lamination direction.

In the battery according to a fourth aspect,
in the first aspect or the second aspect,
a sealing material that is a separate body from the spacer and seals a part between the current collector and the frame body in a liquid tight state is provided between some of the current collector and the frame body.

According to the fourth aspect, the part between some of the current collector and the frame body is sealed in a liquid tight state with the sealing material that is a separate body from the spacer.

In the battery according to a fifth aspect,
in the first aspect or the second aspect,
when the battery is seen in the lamination direction, a distance in the perpendicular direction between an outer peripheral surface of a part of the spacer located between the positive electrode active material layer or the negative electrode active material layer and the frame body and an outer peripheral surface of the negative electrode active material layer is equal to or greater than 10 times of a distance in the lamination direction between the current collectors that are adjacent to each other.

According to the fifth aspect, short-circuiting that tends to raise the temperature of the positive electrode active material layer and the negative electrode active material layer is unlikely to occur between the two current collector foils when an external force is imparted on the battery as compared with a case where the distance in the perpendicular direction between the outer peripheral surface of the portion located between the outer peripheral surface at the part of the spacer located between the positive electrode active material layer or the negative electrode active material layer and the frame body and the outer peripheral surface of the negative electrode active material layer is smaller than 10 times of the distance in the lamination direction between the current collectors that are adjacent to each other.

As described above, the battery according to the present disclosure has an excellent effect that short-circuiting that tends to raise the temperature of the positive electrode active material layer and the negative electrode active material layer is unlikely to occur between the two current collector foils when an external force is imparted on the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view of a bipolar lithium-ion secondary battery according to an embodiment;

FIG. 2 is a schematic cross-sectional view taken along line 2-2 of FIG. 1;

FIG. 3 is a perspective view of the bipolar electrode and spacer in a separated state;

FIG. 4 is a schematic cross-sectional view of a part of a battery according to a first modification;

FIG. 5 is a schematic cross-sectional view of a portion of a second variation of a cell; and

FIG. 6 is a schematic cross-sectional view of a part of a battery according to a third modification.

### DETAILED DESCRIPTION OF EMBODIMENTS

Hereinafter, a bipolar lithium ion secondary battery (hereinafter, referred to as a battery 10) according to an embodiment will be described. The battery 10 can be mounted on a variety of devices. The battery 10 of the present embodiment is mounted on a battery electric vehicle (BEV) and is capable of supplying electric power to an electric motor serving as a drive source. The arrow UP, the arrow FR, and the arrow LH shown in the drawings respectively indicate the upper side in the up-down direction, the front side in the front-rear direction, and the left side in the left-right direction.

First, the basic configuration of the battery 10 will be described. The battery 10 of the present embodiment includes a laminate 15 and a resin member (frame body) 30.

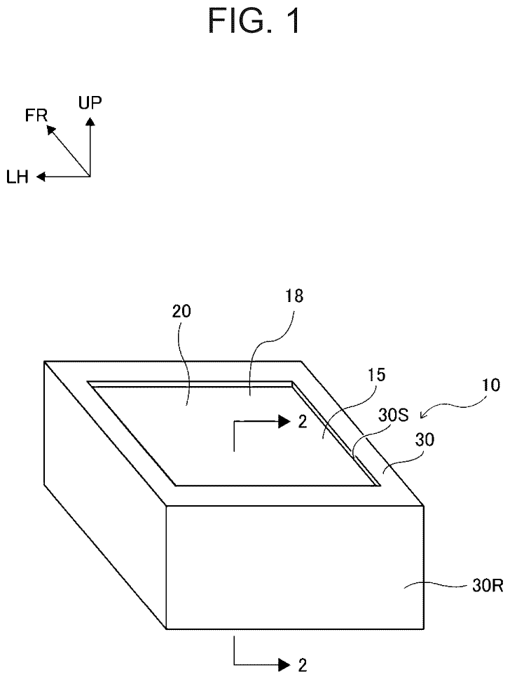

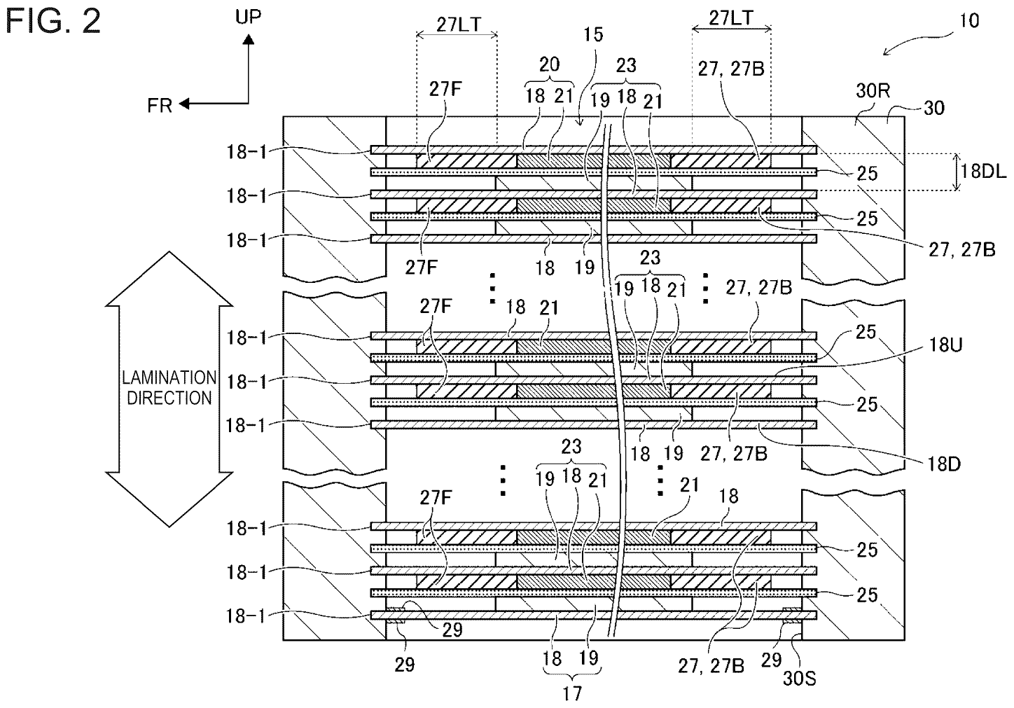

The laminate 15 is formed by stacking a plurality of electrodes, a plurality of separators 25, and a plurality of spacers 27 in a predetermined lamination direction (vertical direction in FIG. 1). These electrodes include a negative electrode termination electrode 17, a positive electrode termination electrode 20, and a plurality of bipolar electrodes 23. In FIG. 2, some of the bipolar electrodes 23 are not shown.

The negative electrode termination electrode 17 includes a current collector 18 and a negative electrode active material layer 19 provided on one surface (upper surface in FIG. 1) of the current collector 18. The positive electrode termination electrode 20 includes a current collector 18 and a positive electrode active material layer 21 provided on one surface (lower surface in FIG. 1) of the current collector 18. Each bipolar electrode 23 includes a current collector 18, a negative electrode active material layer 19 provided on one surface (upper surface in FIG. 2) of the current collector 18, and a positive electrode active material layer 21 provided on the other surface (lower surface in FIG. 2) of the current collector 18.

A separator 25 is provided between the negative electrode active material layer 19 of the negative electrode termination electrode 17 and the positive electrode active material layer 21 of the bipolar electrode 23 adjacent to the negative electrode termination electrode 17. Furthermore, a separator 25 is provided between the positive electrode active material layer 21 of the positive electrode termination electrode 20 and the negative electrode active material layer 19 of the bipolar electrode 23 adjacent to the positive electrode termination electrode 20. Furthermore, a separator 25 is provided between the negative electrode active material layer 19 and the positive electrode termination electrode 20 of the adjacent bipolar electrodes 23.

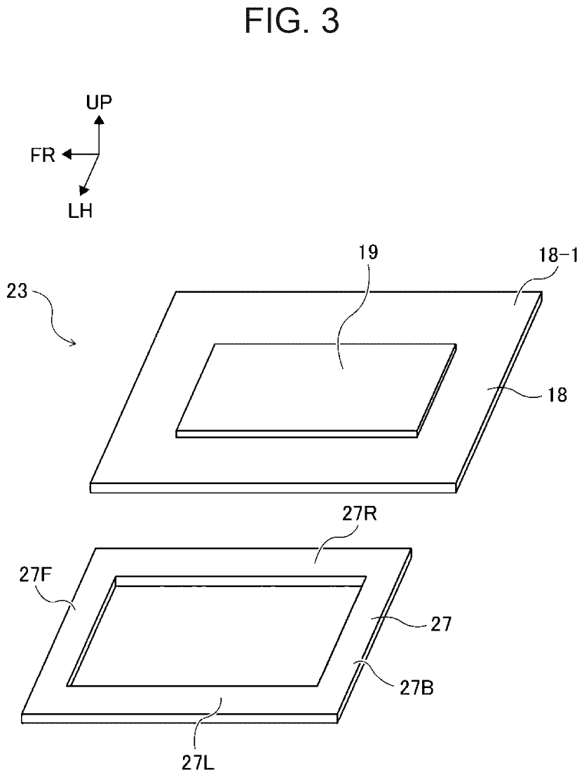

As shown in FIGS. 1 and 2, both end faces in the lamination direction of the laminate 15 including the negative electrode termination electrode 17, the positive electrode termination electrode 20, the bipolar electrode 23, and the separators 25 are constituted by the current collectors 18. As shown in FIGS. 2 and 3, the outer peripheral portion of each current collector 18 when the laminate 15 is viewed along the lamination direction is a current collector foil 18-1 located on the outer peripheral side from the outer peripheral side end portions of the negative electrode active material layer 19 and the positive electrode active material layer 21.

The shape (planar shape) of the laminate 15 of the present embodiment when viewed along the lamination direction is a rectangle. That is, the shapes of the current collectors 18, the negative electrode active material layers 19, the positive electrode active material layers 21, and the separators 25 when the laminate 15 is viewed along the lamination direction are rectangular. Further, as is apparent from FIG. 2, when the laminate 15 is viewed along the lamination direction, the outer peripheral side end portion of each negative electrode active material layer 19 is located on the outer peripheral side from the outer peripheral side end portion of each positive electrode active material layer 21. Furthermore, the shape of each negative electrode active material layer 19 when the laminate 15 is viewed along the lamination direction is the same, and the shape of each positive electrode active material layer 21 when the laminate 15 is viewed along the lamination direction is the same. Further, when the laminate 15 is viewed along the lamination direction, the shapes of the current collectors 18 are the same. Further, when the laminate 15 is viewed along the lamination direction, the shapes of the separators 25 are the same.

Further, as shown in FIGS. 2 and 3, a spacer 27, which is a frame body having a rectangular shape when viewed along the lamination direction, is fixed to the lower surface of the current collector foil 18-1 of each current collector 18 of the positive electrode termination electrode 20 and each bipolar electrode 23. The spacer 27 is made of an insulating and heat-resistant material. For example, the constituent material of the spacer 27 is silicon resin. As is clear from FIG. 2, the rear 27B of the respective spacers 27 are aligned in the vertical direction with the rear end of the respective negative electrode active material layers 19, and the front 27F of the respective spacers 27 are aligned in the vertical direction with the front end of the respective negative electrode active material layers 19. Note that the left side portion 27L (see FIG. 3) of each spacer 27 is aligned with the left end portion of each negative electrode active material layer 19 in the up-down direction, and the right side portion 27R (see FIG. 3) of each spacer 27 is aligned with the right end portion of each negative electrode active material layer 19 in the up-down direction. Further, the inner peripheral surface of each spacer 27 and the outer peripheral surface of each positive electrode active material layer 21 face each other while forming a minute gap. Further, the vertical dimension (thickness) of each spacer 27 is the same as the vertical dimension (thickness) of each positive electrode active material layer 21. Therefore, the lower surface of each spacer 27 is in contact with the upper surface of the separator 25.

Here, a direction orthogonal to the lamination direction (vertical direction) is defined as a perpendicular direction. That is, the left-right direction and the front-rear direction are included in the perpendicular direction. The distance 27LT in the front-rear direction between the front end face on the front 27F of the spacer 27 and the front end face of the negative electrode active material layers 19 (see FIG. 2) is substantially longer than the distance 18DL in the lamination direction between the adjacent current collectors 18 (see FIG. 2). The distance 27LT in the front-rear direction between the rear end face on the rear 27B of the spacer 27 and the rear end face of the negative electrode active material layers 19 (see FIG. 2) is substantially longer than the distance 18DL in the lamination direction between the adjacent current collectors 18 (see FIG. 2). The distance 27LT (not shown) in the left-right direction between the left side surface of the left side portion of the spacer 27 and the left end surface of the negative electrode active material layer 19 is substantially longer than the distance 18DL (see FIG. 2) in the lamination direction between the adjacent current collectors 18. The distance 27LT (not shown) in the left-right direction between the right side surface of the right side portion of the spacer 27 and the right end surface of the negative electrode active material layer 19 is substantially longer than the distance 18DL (see FIG. 2) in the lamination direction between the adjacent current collectors 18. The distance 18DL is a vertical distance between the upper surface of one current collector 18 and the lower surface of the current collector 18 adjoining from above with respect to the current collector 18. Further, it is preferable that the respective distances 27LT have a length of 10 times or more of the distance 18DL.

A resin member 30, which is an integrally molded product made of resin, is provided on the outer peripheral portion of the laminate 15. The resin member 30 is integrated with the outer peripheral portion of the laminate 15 in an airtight state and a liquid-tight state so as to cover the outer peripheral portion of the laminate 15. The shape of the resin member 30 when cut in a cross section perpendicular to the lamination direction is a rectangle having a rectangular opening formed in the central portion. The resin member 30 is made of an insulating resin material. The constituent material of the resin member 30 is, for example, polypropylene, polyethylene, polystyrene, ABS resin, acid-modified polypropylene, acid-modified polyethylene, or acrylonitrile styrene resin. For example, the resin member 30 may be integrally provided on the outer peripheral portion of the laminate 15 by insert molding performed while the laminate 15 is disposed inside a mold (not shown).

Although not shown, an electrolytic solution is provided inside the laminate 15, and the electrolytic solution is impregnated into the negative electrode termination electrode 17, the positive electrode termination electrode 20, and the bipolar electrode 23.

Further, as shown in FIG. 2, a sealing material 29 made of an insulating material is formed in a liquid-tight manner on the entire surface of the end portion on the inner peripheral surface side of the central opening portion 30S of the current collector foil 18-1 of the current collector 18 and the inner peripheral surface on the central opening portion 30S. In FIG. 2, the sealing material 29 is shown only in the current collector foil 18-1 of the current collector 18 located at the lowermost position, and the sealing material 29 of the other current collectors 18 (current collector foil 18-1) is not shown.

The battery 10 having the above-described configuration is fixed to an upper surface of a substantially horizontal plate member (not shown) that forms a part of the vehicle body constituent member of the above-described battery electric vehicle via a fixing unit.

As shown in FIGS. 1 and 2, the negative electrode termination electrode 17, the positive electrode termination electrode 20, the outer peripheral side end portions of the respective current collectors 18 of the bipolar electrodes 23, and the outer peripheral side end portions of the respective separators 25 are located inside the resin member 30. On the other hand, the outer peripheral side end portions of the respective negative electrode active material layers 19 and the respective positive electrode active material layers 21 are located on the inner peripheral side with respect to the inner peripheral surface of the central opening portion 30S of the resin member 30. Furthermore, the current collector 18 of the negative electrode termination electrode 17 is exposed through one opening end portion of the central opening portion 30S, and the current collector 18 of the positive electrode termination electrode 20 is exposed through the other opening end portion of the central opening portion 30S. Therefore, the electric power generated by the battery 10 can be supplied to various electric devices and electronic devices (not shown) provided in battery electric vehicle via the first conductive member (not shown) and the second conductive member (not shown). The first conductive member is connected to the current collector 18 of the negative electrode termination electrode 17 via one opening end portion of the central opening portion 30S. The second conductive member is connected to the current collector 18 of the positive electrode termination electrode 20 via the other open end of the central opening portion 30S.

### Action and Effect

Next, the operation and effects of the present embodiment will be described.

Here, it is assumed that vehicles (not shown) traveling forward in the rear area of battery electric vehicle collide with the rear end portion of battery electric vehicle. When such a collision occurs in the above-described battery electric vehicle, a member (not shown) provided on the vehicle body and positioned immediately after the battery 10 may move forward relative to the battery 10 and violently collide with the rear 30R (see FIGS. 1 and 2) of the resin member 30.

In this case, the current collector foil 18-1 of the current collector 18U, which is, for example, one current collector 18, may be deformed by an external force applied to the battery 10, and may come into contact with the current collector foil 18-1 of the current collector 18D, which is another current collector 18, while passing through the neighboring separators 25. However, as shown in FIG. 2, the distance in the front-rear direction from the rear 27B of the spacer 27 fixed to the lower surface of the current collector foil 18-1 of the current collector 18U to the rear 30R of the resin member 30 is shorter than the distance in the front-rear direction from the rear 27B to the rear end surfaces of the negative electrode active material layer 19 and the positive electrode active material layer 21. That is, the rear 27B is fixed to the current collector foil 18-1 of the current collector 18U in such a manner as to be close to the rear end portions of the negative electrode active material layer 19 and the positive electrode active material layer 21. Therefore, a portion of the current collector 18U located behind the rear 27B of the current collector foil 18-1 contacts the current collector foil 18-1 of the current collector 18D while passing through the neighboring separators 25. That is, the spacer 27 (rear 27B) located between the collector 18U and the separator 25 suppresses a portion where the distance to the negative electrode active material layer 19 and the positive electrode active material layer 21 of the current collector foil 18-1 18U is short from contacting the current collector foil 18-1 of the current collector 18D. For example, there is little possibility that a portion of the current collector 18U located in front of the rear end of the rear 27B of the current collector foil 18-1 contacts the current collector foil 18-1 of the current collector 18D. If a portion where the distance to the negative electrode active material layer 19 and the positive electrode active material layer 21 of the current collector foil 18-1 of the current collector 18U of the battery 10 is short contacts the current collector foil 18-1 of the current collector 18D, the distance between the short-circuit portion of the current collector 18U, 18D and the negative electrode active material layer 19 and the positive electrode active material layer 21 is short, there is a possibility that the negative electrode active material layer 19 and the positive electrode active material layer 21 become high temperature by heat generated at the short-circuit portion. On the other hand, when the portion of the current collector 18U located behind the rear 27B of the current collector foil 18-1 contacts the current collector foil 18-1 on the current collector 18D while passing through the neighboring separators 25, the distance between the short-circuited portion of the current collector 18U, 18D and the negative electrode active material layer 19 and the positive electrode active material layer 21 is increased, and therefore, there is little possibility that the temperature of the negative electrode active material layer 19 and the positive electrode active material layer 21 is increased due to the heat generated at the short-circuited portion.

Further, when the distance 27LT in the front-rear direction between the rear end face of the rear 27B and the rear end face of the negative electrode active material layer 19 is set to be 10 times or more the length of the distance 18DL in the lamination direction between the adjacent current collectors 18, the risk of the negative electrode active material layer 19 and the positive electrode active material layer 21 becoming higher due to the heat generated at the short-circuit portion becomes smaller than that in the case where the distance 27LT is smaller than 10 times the distance 18DL.

Further, the vertical dimension (thickness) of each spacer 27 is the same as the vertical dimension (thickness) of each positive electrode active material layer 21. That is, at a point in time before the external force is applied to the battery 10, the upper surface of the spacer 27 contacts the lower surface of the current collector foil 18-1, and the lower surface of the spacer 27 contacts the upper surface of the separator 25. Therefore, the spacer 27 is more likely to prevent the two current collector foils 18-1 from being short-circuited with each other than the case where the spacer 27 does not contact the lower surface of the current collector foil 18-1 or the upper surface of the separator 25 at a time point before the external force is applied to the battery 10.

Although the battery 10 according to the embodiment has been described above, it is possible to appropriately change the design without departing from the gist of the present disclosure.

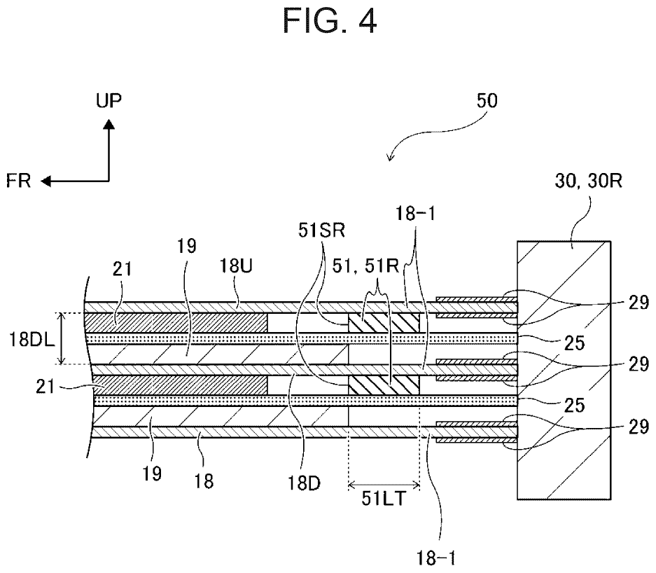

The battery 50 of the first modification illustrated in FIG. 4 has the same structure as the battery 10 of the embodiment except that the dimensions of the spacer 51 in the front-rear direction and the left-right direction are different from those of the spacer 27. The rear 51SR of the inner peripheral surface of the spacer 51 is vertically aligned with the rear end surface of the negative electrode active material layers 19. That is, the rear portion 51SR of the inner peripheral surface of the spacer 51 and the rear end surface of the negative electrode active material layer 19 are located at the same position. Although not shown, the front portion of the inner peripheral surface of the spacer 51 is aligned with the front end surface of the negative electrode active material layer 19 in the vertical direction. The left side portion of the inner peripheral surface of the spacer 51 is aligned with the left end surface of the negative electrode active material layer 19 in the vertical direction. The right side portion of the inner peripheral surface of the spacer 51 is aligned with the right end surface of the negative electrode active material layer 19 in the vertical direction. Further, the distance 51LT between the front end face of the front portion of the spacer 51 and the front end face of the negative electrode active material layers 19 is substantially longer than the distance 18DL. The front-rear distance 51LT between the rear end face of the rear 51R of the spacer 51 and the rear end face of the negative electrode active material layers 19 is substantially longer than the distance 18DL. The lateral distance 51LT between the left side surface of the left side portion of the spacer 51 and the left end surface of the negative electrode active material layer 19 is substantially longer than the distance 18DL. The lateral distance 51LT between the right side surface of the right side portion of the spacer 51 and the right end surface of the negative electrode active material layer 19 is substantially longer than the distance 18DL. Further, it is preferable that the respective distances 51LT have a length of 10 times or more of the distance 18DL. In the battery 50 of the first modification shown in FIG. 4, when an external force is applied to the battery 50, the spacer 51 (rear 51R) suppresses the current collector foil 18-1 of the current collector 18U from contacting the current collector foil 18-1 of the current collector 18D with a portion of the current collector foil 18-1 of the current collector 18U having a short longitudinal distance from the negative electrode active material layer 19 to the positive electrode active material layer 21. Therefore, when an external force is applied to the battery 50, a short circuit that easily raises the temperature of the negative electrode active material layer 19 and the positive electrode active material layer 21 is unlikely to occur between the two current collector foils 18-1.

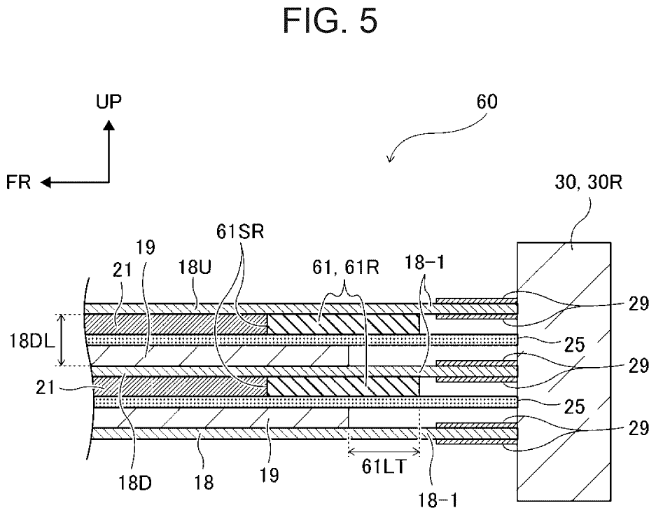

The battery 60 of the second modification illustrated in FIG. 5 has the same structure as the battery 10 of the embodiment except that the dimensions of the spacer 61 in the front-rear direction and the left-right direction are different from those of the spacer 27. The rear 61SR of the inner peripheral surface of the spacer 61 contacts the rear end surface of the positive electrode active material layers 21. Although not shown, the front portion of the inner peripheral surface of the spacer 61 contacts the front end surface of the positive electrode active material layer 21, the left side portion of the inner peripheral surface of the spacer 61 contacts the left end surface of the positive electrode active material layer 21, and the right side portion of the inner peripheral surface of the spacer 61 contacts the right end surface of the positive electrode active material layer 21. Further, the distance 61LT between the front end face of the front portion of the spacer 61 and the front end face of the negative electrode active material layers 19 is substantially longer than the distance 18DL. The front-rear distance 61LT between the rear end face of the rear 61R of the spacer 61 and the rear end face of the negative electrode active material layers 19 is substantially longer than the distance 18DL. The lateral distance 61LT between the left side surface of the left side portion of the spacer 61 and the left end surface of the negative electrode active material layer 19 is substantially longer than the distance 18DL. The lateral distance 61LT between the right side surface of the right side portion of the spacer 61 and the right end surface of the negative electrode active material layer 19 is substantially longer than the distance 18DL. Further, it is preferable that the respective distances 61LT have a length of 10 times or more of the distance 18DL. In the battery 60 of the second modification illustrated in FIG. 5, the spacer 61 (the rear 61R) suppresses a portion of the current collector 18U where the negative electrode active material layer 19 and the positive electrode active material layer 21 of the current collector foil 18-1 are short in length from contacting the current collector foil 18-1 of the current collector 18D. Therefore, when an external force is applied to the battery 60, a short circuit that easily raises the temperature of the negative electrode active material layer 19 and the positive electrode active material layer 21 is unlikely to occur between the two current collector foils 18-1. Further, since the inner peripheral side end portion of the spacer 61 is located on the inner peripheral side (the positive electrode active material layer 21 side) from the inner peripheral side end portions of the spacers 27 and 51, the mechanical strength of the battery 60 is higher than that of the batteries 10 and 50.

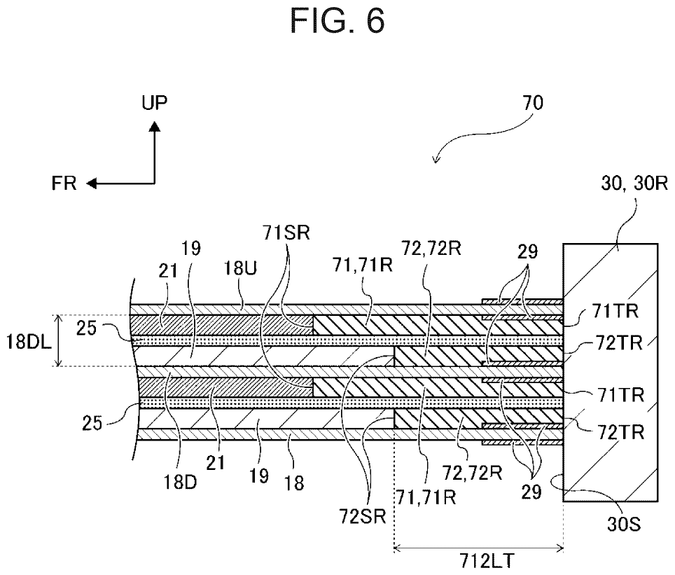

The battery 70 of the third modification illustrated in FIG. 6 has the same structure as the battery 10 of the embodiment except that the dimensions of the spacer 71 in the front-rear direction and the left-right direction are different from those of the spacer 27 and that the spacer 72 is provided. The rear 71SR of the inner peripheral surface of the spacer 71 facing the positive electrode active material layer 21 in a perpendicular direction contacts the rear end surface of the positive electrode active material layer 21. Although not shown, the front portion of the inner peripheral surface of the spacer 71 contacts the front end surface of the positive electrode active material layer 21, the left side portion of the inner peripheral surface of the spacer 71 contacts the left end surface of the positive electrode active material layer 21, and the right side portion of the inner peripheral surface of the spacer 71 contacts the right end surface of the positive electrode active material layer 21. Further, the rear 71TR of the outer peripheral surface of the spacer 71 contacts the rear portion of the inner peripheral surface of the central opening portion 30S of the resin member 30. Although not shown, the front portion of the outer peripheral surface of the spacer 71 contacts the front portion of the inner peripheral surface of the central opening portion 30S. The left side portion of the outer peripheral surface of the spacer 71 contacts the left side portion of the inner peripheral surface of the central opening portion 30S. The right side portion of the outer peripheral surface of the spacer 71 contacts the right side portion of the inner peripheral surface of the central opening portion 30S.

The battery 70 includes a spacer 72 that faces the negative electrode active material layer 19 in the perpendicular direction. The shape of the spacer 72 when viewed along the lamination direction is also a rectangular frame body like the spacers 27, 51, 61, and 71. The vertical dimension (thickness) of the spacer 72 is the same as the vertical dimension (thickness) of each negative electrode active material layer 19. The rear 72SR of the inner peripheral surface of the spacer 72 contacts the rear end surface of the negative electrode active material layers 19. Although not shown, the front portion of the inner peripheral surface of the spacer 72 contacts the front end surface of the negative electrode active material layer 19, the left side portion of the inner peripheral surface of the spacer 72 contacts the left end surface of the negative electrode active material layer 19, and the right side portion of the inner peripheral surface of the spacer 72 contacts the right end surface of the negative electrode active material layer 19. Further, the rear 72TR of the outer peripheral surface of the spacer 72 contacts the rear portion of the inner peripheral surface of the central opening portion 30S of the resin member 30. The front portion of the outer peripheral surface of the spacer 72 is in contact with the front end surface of the inner peripheral surface of the central opening portion 30S, the left side portion of the outer peripheral surface of the spacer 72 is in contact with the left end surface of the inner peripheral surface of the central opening portion 30S, the right side portion of the outer peripheral surface of the spacer 72 is in contact with the right end surface of the inner peripheral surface of the central opening portion 30S.

Further, the distance 712LT between the front end face of the front portion of the spacers 71 and 72 and the front end face of the negative electrode active material layers 19 is substantially longer than the distance 18DL. The front-rear distance 712LT between the rear end face of the rear 71R, 72R and the rear end face of the negative electrode active material layers 19 is substantially longer than the distance 18DL. The lateral distance 712LT between the left side surface of the left side portions of the spacers 71 and 72 and the left end surface of the negative electrode active material layers 19 is substantially longer than the distance 18DL. The lateral distance 712LT between the right side surface of the right side portions of the spacers 71 and 72 and the right end surface of the negative electrode active material layers 19 is substantially longer than the distance 18DL. Further, it is preferable that the respective distances 712LT have a length of 10 times or more of the distance 18DL.

Thus, the annular space between the outer peripheral surface of the positive electrode active material layer 21 and the inner peripheral surface of the central opening portion 30S of the resin member 30 is completely closed by the spacer 71, and the annular space between the outer peripheral surface of the negative electrode active material layer 19 and the inner peripheral surface of the central opening portion 30S of the resin member 30 is completely closed by the spacer 72. Therefore, when an external force is applied to the battery 70, there is little possibility that a short circuit occurs between the two current collector foils 18-1. When the rear 30R is destroyed due to the impact, there is a possibility that the portions located behind the rear 71TR, 72TR of the current collector 18U, 18D are short-circuited. However, in this case, the short-circuited portion of the current collector 18U, 18D and the negative electrode active material layer 19 and the positive electrode active material layer 21 are long in the front-rear direction, so that the negative electrode active material layer 19 and the positive electrode active material layer 21 are unlikely to become high in temperature due to heat generated at the short-circuited portion.

The upper and lower dimensions (thicknesses) of the spacers 27, 51, 61, and 71 may be smaller than the upper and lower dimensions (thicknesses) of the positive electrode active material layers 21. The vertical dimension (thickness) of the spacer 72 may be smaller than the vertical dimension (thickness) of each negative electrode active material layer 19.

The battery of the present disclosure may include only one of a spacer facing the positive electrode active material layer 21 in the perpendicular direction and a spacer facing the negative electrode active material layer 19 in the perpendicular direction.

The number of electrodes provided in the battery 10 may be any number as long as the number of electrodes is plural.

The battery 10 may be provided in a device other than battery electric vehicle.

What is claimed is:

1. A battery comprising:
a laminate configured by laminating a plurality of bipolar electrodes and a plurality of separators in a predetermined lamination direction, the bipolar electrodes each including
a current collector, a positive electrode active material layer provided on one surface of the current collector and including an outer peripheral side end portion located on a side closer to an inner periphery than an outer peripheral side end portion of the current collector, and
a negative electrode active material layer provided on another surface of the current collectors and including an outer peripheral side end portion located on the side closer to the inner periphery than the outer peripheral side end portion of the current collector, the separators being each located between the positive electrode active material layer and the negative electrode active material layer;
a frame body that is made of resin and is provided at an outer peripheral portion of the laminate such that the frame body is connected to current collector foils that are parts of the current collectors where the positive electrode active material layers and the negative electrode active material layers are not provided; and
a spacer that is made of an insulating material and is located between the current collector foil and the separator such that a distance in a perpendicular direction up to the positive electrode active material layer and the negative electrode active material layer is longer than a distance in the perpendicular direction up to the frame body, the perpendicular direction being a direction perpendicularly intersecting the lamination direction.

2. The battery according to claim 1, wherein:
the outer peripheral side end portion of the negative electrode active material layer is located on a side closer to an outer periphery than the outer peripheral side end portion of the positive electrode active material layer;
the spacer is provided on the current collector such that the spacer faces the positive electrode active material layer in the perpendicular direction from an outer peripheral side; and
at least some of the spacer overlaps the outer peripheral side end portion of the negative electrode active material layer as viewed in the lamination direction.

3. The battery according to claim 1, wherein a dimension of the spacer and a dimension of the positive electrode active material layer in the lamination direction are the same.

4. The battery according to claim 1, wherein a sealing material that is a separate body from the spacer and seals a part between the current collector and the frame body in a liquid tight state is provided between some of the current collector and the frame body.

5. The battery according to claim 1, wherein when the battery is seen in the lamination direction, a distance in the perpendicular direction between an outer peripheral surface of a part of the spacer located between the positive electrode active material layer or the negative electrode active material layer and the frame body and an outer peripheral surface of the negative electrode active material layer is equal to or greater than 10 times of a distance in the lamination direction between the current collectors that are adjacent to each other.
